(19) United States
(12) Patent Application Publication
(10) Pub. No.: US 2008/0160262 A1
(43) Pub. Date: Jul. 3, 2008

(54) SURFACE TREATMENT PROCESS FOR COLORING METAL ARTICLES

(75) Inventors: CHIH-PEN LIN, Shindian (TW); ZHI-MIN LI, Shenzhen (CN); GUO-YOU XIONG, Shenzhen (CN); HUA-JIE ZHENG, Shenzhen (CN); XIAN-FENG LUO, Shenzhen (CN); ZHENG-GANG XIE, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: SHENZHEN FUTAIHONG PRECISION INDUSTRY CO., LTD., ShenZhen City (CN); SUTECH TRADING LIMITED, Tortola (VG)

(21) Appl. No.: 11/860,454

(22) Filed: Sep. 24, 2007

(30) Foreign Application Priority Data
Dec. 29, 2006 (CN) 200610064622.6

(51) Int. Cl. B05B 5/00

(52) U.S. Cl. 428/195.1; 427/470

(57) ABSTRACT

A surface treatment process for coloring metal articles includes following steps. Firstly, a metal article with a surface including a first surface portion and a second surface portion is provided. Secondly, a releasable coating is formed onto the first surface portion of the metal article. Thirdly, a first electro-depositable coating is applied onto the second surface portion of the metal article by means of a first electro-coat process. Fourthly, the releasable coating is removed from the first surface portion of the metal article. Finally, a second electro-depositable coating having a color different from that of the first electro-depositable coating is applied onto the first surface portion of the metal article by means of a second electro-coat process.

### BACKGROUND OF THE INVENTION

1. Field of the Invention

The present invention relates generally to surface treatment processes for coloring metal articles, and more particularly, to a surface treatment process for coloring metal articles using an electro-coat process.

2. Description of Related Art

Deposition processes known as electro-coat or electro-deposition have tremendous applications in manufacture of decorative metal articles. In a typical electro-coat process, paint particles (e.g., pigment and resin) maintained as a colloidal suspension in an electrophoresis solution are either positively or negatively charged. A metal article to be electro-coated is submersed in the electrophoresis solution and serves as a cathode or an anode. When an electrical field is applied between the metal article and a counter electrode corresponding to the metal article by means of a direct power supply, the paint particles are thereby attracted to and deposited on the metal article. However, the color of the paint particles cannot be altered during electro-coat or electro-depositing. Thus only a single-color appearance can be obtained by means of the electro-coat process. In fact, multi-colors appearance of the metal article is desired with requirements of the consumers.

Therefore, a surface treatment process for coloring metal articles is desired, in order to overcome the above-described shortcomings.

### SUMMARY OF THE INVENTION

In one embodiment thereof, a surface treatment process for coloring metal articles is provided. In a first step of the electro-coat process, a metal article with a surface including a first surface portion and a second surface portion is provided. In a second step of the electro-coat process, a releasable coating is formed onto the first surface portion of the metal article. In a third step of the electro-coat process, a first electro-depositable coating is applied onto the second surface portion of the metal article by means of a first electro-coat process. In a fourth step of the electro-coat process, the releasable coating is removed from the first surface portion of the metal article. In a fifth step of the electro-coat process, a second electro-depositable coating having a color different from that of the first electro-depositable coating is applied onto the first surface portion of the metal article by means of a second electro-coat process.

Other advantages and novel features will become more apparent from the following detailed description of preferred embodiments when taken in conjunction with the accompanying drawings.

### BRIEF DESCRIPTION OF THE DRAWINGS

Many aspects of the surface treatment process for coloring metal articles can be better understood with reference to the following drawing. The components in the drawing are not necessarily drawn to scale, the emphasis instead being placed upon clearly illustrating the principles of the surface treatment process for coloring metal articles. Moreover, in the drawing like reference numerals designate corresponding parts throughout the several views.

FIG. 1 is a flow chart of a surface treatment process for coloring metal articles in accordance with a present embodiment.

### DETAILED DESCRIPTION OF THE INVENTION

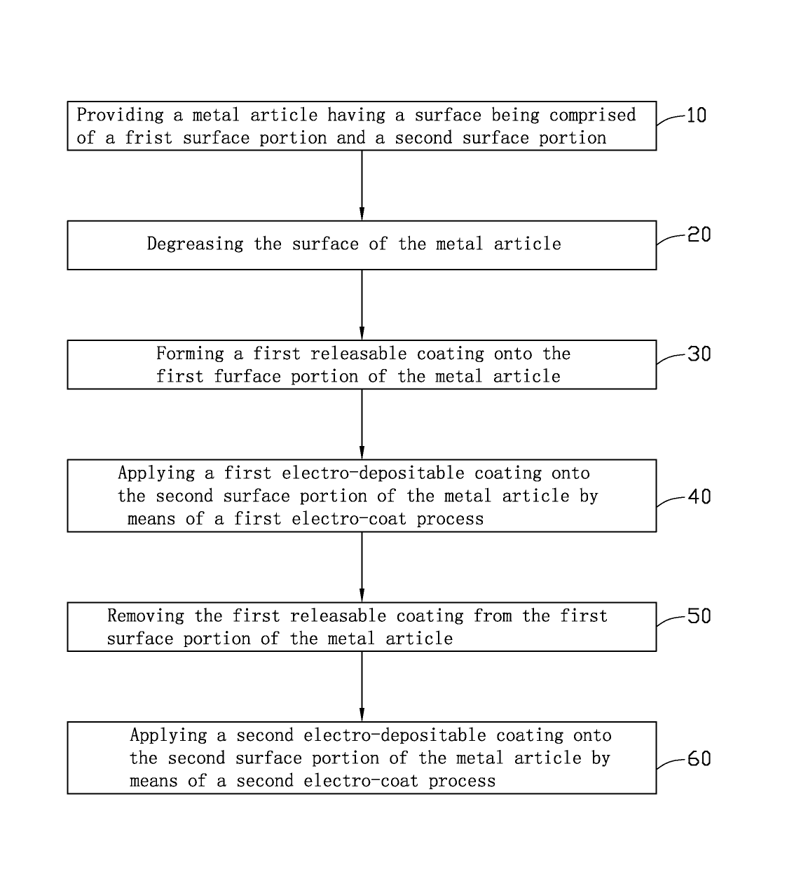

Referring to FIG. 1, in a present embodiment, a surface treatment process for coloring metal articles includes the following steps: step 10, providing a metal article having a surface being comprised of a first surface portion and a second surface portion; step 20, degreasing the surface of the metal article; step 30, forming a first releasable coating onto the first surface portion of the metal article; step 40, applying a first electro-depositable coating onto the second surface portion of the metal article by means of a first electro-coat process; step 50, removing the first releasable coating from the first surface portion of the metal article; and step 60, applying a second electro-depositable coating onto the first surface portion of the metal article by means of a second electro-coat process. Detailed description about the above steps is as following:

In step 10, a metal article made of at least one of steel, aluminum, copper, magnesium, zincum, or alloys thereof is provided. The metal article has a surface including a first surface portion and a second surface portion adjacent to the first surface portion.

In step 20, a process for degreasing a surface of the metal article is carried out using an alkali-based cleaning solution to remove oil stains on the metal article. The alkali-based cleaning solution may include at least one of sodium hydroxide, sodium carbonate, and sodium phosphate. After being degreased, the metal article is subsequently rinsed in flowing water. It is to be understood that, alternatively, another degreasing agent such as a surfactant could be employed in step 20.

In step 30, a non-conductive first releasable coating is formed onto the first surface portion of the metal article, so as to prevent the first surface portion of the metal article from being coated in a subsequent electro-deposition process. The first releasable coating may be a resoluble resin composition, such as resoluble ink. The formation of the first releasable coating may be carried out via brushing, spray painting, or screen printing.

In step 40, a first electro-depositable coating is applied onto the second surface portion of the metal article by means of a first electro-coat process. The first electro-coat process is performed via dipping the metal article in a first electro-coat solution containing deionized water in an approximate range from 80 to 90 wt % (percent by weight) and a first electro-coat paint composition in an approximate range from 5 to 20 wt %, for 30 to 120 seconds. The first electro-coat paint may, advantageously, be an anodic electro-coat paint, e.g., epoxy resin paint and poly acrylic acid paint. A voltage applied between the metal article and one or more counter electrodes may be in a range from 30 to 300 volts. As such, during the first electro-coat process, the first electro-depositable coating is formed on the second surface portion of the metal article, with the first surface portion not being coated with the anodic electro-coat paint.

In step 50, the first releasable coating is removed from the first surface portion of the metal article, so as to expose the first surface portion of the metal article. An organic solvent such as dimethylbenzene is used to dissolve and remove the first releasable coating.

In step 60, a second electro-depositable coating is applied onto the first surface portion of the metal article by means of a second electro-coat process. The second electro-coat process is performed via dipping the metal article in a second electro-coat solution containing deionized water in an approximate range from 80 to 90 wt % and a second electro-coat paint composition in an approximately range from 5 to 20 wt %, for 30 to 120 seconds. The second electro-coat paint may, advantageously, be a cathodic electro-coat paint, e.g., polyurethane paint and vinyl copolymer paint. A voltage applied between the metal article and one or more counter electrodes may be in a range from 30 to 300 volts. As such, during the second electro-coat process, the second electro-depositable coating is formed on the first surface portion of the metal article.

The second surface portion of the metal article should not be double coated because of protection of the first electro-depositable coating. The second electro-coating has a color different from that of the first electro-coating, thus a metal article having a surface with two-colors appearance can be obtained by means of the above-described processes.

It should be understood that a further optional step could be performed after the step 50 and before the step 60. In the further additional step, the first surface portion of the metal article is partially coated with a second releasable coating, which may be the same as the first releasable coating. Thus, the first surface portion of the metal article at this moment may include a first section coated with the second releasable coating and a second section not coated with the second releasable coating. The step 60 is then performed to coat the second section of the first surface portion with the second electro-coating. After the step 60, the second releasable coating is removed by means of that similar to the step 50. A third electro-coat process is then carried out to coat a third electro-coating onto the first section of the first surface portion. The third electro-coating is comprised of a third electro-depositable paint. Each of the first electro-coating, the second electro-coating, and the third electro-coating has a color different from others. The third electro-coating has a color different from that of the first electro-coating and the second electro-coating, thus a metal article having a surface with three-colors appearance can be obtained by means of the above-described processes.

It should be understood, however, that one of the first electro-coating, the second electro-coating, and the third electro-coating may be colorless, a metal article having a surface with multi-colors appearance could also be obtained by means of the above-described processes.

It should be understood, however, that the first electro-depositable paint employed in step 40 could instead be a cathodic electro-depositable paint, and the second electro-depositable paint employed in step 60 could instead be an anodic electro-depositable paint.

It should be understood, however, that at least one of the first electro-depositable paint, the second electro-depositable paint, and the third electro-depositable paint should, advantageously, have an organic dye composition (e.g., phthalocyanine and diazole compounds) or an inorganic dye composition (e.g., titanium oxide, ferric oxide, and carbon black) added thereto.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A surface treatment process for coloring metal articles, comprising steps of:
providing a metal article with a surface including a first surface portion and a second surface portion;
forming a releasable coating onto the first surface portion of the metal article;
applying a first electro-depositable coating onto the second surface portion of the metal article by means of a first electro-coat process;
removing the releasable coating from the first surface portion of the metal article; and
applying a second electro-depositable coating having a color different from that of the first electro-depositable coating onto the first surface portion of the metal article by means of a second electro-coat process.

2. The surface treatment process for coloring metal articles as claimed in claim 1, wherein the first electro-depositable coating is comprised of an anodic electro-coat paint, the second electro-depositable coating being comprised of an anodic electro-coat paint.

3. The surface treatment process for coloring metal articles as claimed in claim 2, wherein at least one of the anodic electro-coat paint and the anodic electro-coat paint have an organic dye composition or an inorganic dye composition added thereto.

4. The surface treatment process for coloring metal articles as claimed in claim 1, wherein the first electro-depositable coating is comprised of a cathodic electro-coat paint, the second electro-depositable coating being comprised of an anodic electro-coat paint.

5. The surface treatment process for coloring metal articles as claimed in claim 4, wherein at least one of the anodic electro-coat paint and the anodic electro-coat paint have an organic dye composition or an inorganic dye composition added thereto.

6. The surface treatment process for coloring metal articles as claimed in claim 1, wherein the releasable coating is comprised of a resoluble ink.

7. The surface treatment process for coloring metal articles as claimed in claim 1, wherein the first electro-coat process is performed via dipping the metal article in a first electro-coat solution containing deionized water in an approximate range from 80 to 90 wt % and a first paint composition in an approximate range from 5 to 20 wt % for 30 to 120 seconds.

8. The surface treatment process for coloring metal articles as claimed in claim 1, wherein the second electro-coat process is performed via dipping the metal article in a second electro-coat solution containing deionized water in an approximate range from 80 to 90 wt % and a second paint composition in an approximate range from 5 to 20 wt % for 30 to 120 seconds.

9. A surface treatment process for coloring metal articles, comprising steps of:
providing a metal article with a surface including a first surface portion and a second surface portion;
forming a first releasable coating onto the first surface portion of the metal article;
applying a first electro-depositable coating onto the second surface portion of the metal article by means of a first electro-coat process;
removing the first releasable coating from the first surface portion of the metal article;
forming a second releasable coating onto a part of the first surface portion of the metal article, thus defining the first surface portion into a first section coated with second releasable coating and a second section uncoated;
applying a second electro-depositable coating onto the second section of the first surface portion of the metal article by means of a second electro-coat process;
removing the second releasable coating from the first section of the first surface portion of the metal article; and
applying a third electro-depositable coating onto the first section of the first surface portion of the metal article by means of a third electro-coat process;
wherein, each of the first electro-depositable coating, the second electro-depositable coating, and the third electro-depositable coating has a color different from others.

10. The surface treatment process for coloring metal articles as claimed in claim 9, wherein the first releasable coating and the second releasable coating are comprised of a resoluble ink.

11. The electro-coat process for metal articles as claimed in claim 9, wherein each of the first electro-coat process, the second electro-coat process, and the third electro-coat process is performed via dipping the metal article in a respective electro-coat solution containing deionized water in an approximate range from 80 to 90 wt % and a respective paint composition in an approximate range from 5 to 20 wt % for 30 to 120 seconds.

12. A metal article, comprising:
a surface including at least two surface portion, one of the at least two surface portions being coated with a first electro-coating, another one of the at least two surface portions being coated with a second electro-coating, wherein the first electro-coating has a color different from the second electro-coating.
